(19) United States
(12) Patent Application Publication
(10) Pub. No.: US 2016/0239296 A1
(43) Pub. Date: Aug. 18, 2016

(54) COBOL COPYBOOK CONFIGURATION SYSTEM USABLE IN AN EMULATED INTEGRATED DEVELOPMENT ENVIRONMENT (IDE)

(71) Applicants: Gaurav Ahuja, Bangalore (IN); Anand Prakash, Bangalore (IN); Swetha Shetty, Bangalore (IN); Mahesh Maney, Bangalore (IN)

(72) Inventors: Gaurav Ahuja, Bangalore (IN); Anand Prakash, Bangalore (IN); Swetha Shetty, Bangalore (IN); Mahesh Maney, Bangalore (IN)

(73) Assignee: UNISYS CORPORATION, Blue Bell, PA (US)

(21) Appl. No.: 14/667,866

(22) Filed: Mar. 25, 2015

(30) Foreign Application Priority Data
Feb. 13, 2015 (IN) 422/DEL/2015

(51) Int. Cl. G06F 9/44; G06F 17/30

(52) U.S. Cl. CPC G06F 8/71; G06F 17/30091

(57) ABSTRACT

A method and apparatus for copy process configuration in an emulated integrated development environment (IDE). The configuration may allow users to easily refer to the files that contain copy processes. Users may configure copy processes just by specifying the workfile names that contain the elements of the copy process definitions. Users may also view the absolute path of the definition files selecting a copy process name in a program code.

### FIELD OF THE DISCLOSURE

The instant disclosure relates to computer systems. More specifically, this disclosure relates to a COBOL copybook or copy process (copy-proc) configuration system usable in an emulated integrated development environment (IDE).

### BACKGROUND

In conventional emulated environments, such as OS 2200 or other suitable environments, a user/developer may view and edit data files and elements in program files using a variety of editors provided by one or more hosts. These editors may be compatible with a variety of programming languages, such as Java, COBOL, C++, and others. When using COBOL, in particular, the user may wish to reference various copy processes (copy-procs) or copy-books. A copy-proc is a reusable piece of code or group of variable definitions that may be inserted into several different COBOL programs. However, if a user does not know about the existence or location of the file that contains the copy-proc definitions, it may be difficult for the user to locate the file and refer to the copy-procs in the file. Further, for COBOL programs with multiple copy-procs, the locations of the files may be different. Thus, there is a desire for a user-friendly interface to assist users in locating and referring to files that contain copy-procs.

### SUMMARY

A COBOL copybook or copy process (copy-proc) configuration system within an IDE is provided. In some embodiments, a method of referring to one or more copy processes (copy-procs) within an integrated development environment comprises receiving an input term comprising one or more workfile names; displaying a list of workfile contents; creating a file-path map for one or more of the workfile contents; receiving a query input; and displaying the file-path corresponding to the query input. In some embodiments, the one or more workfiles contain definition elements for one or more copy-procs and the list of workfile contents comprises a procedure table and an element table.

In some embodiments, creating the file-path map comprises parsing the procedure table; creating a procedure map; parsing the element table; creating one or more sequence numbers; correlating the procedure map and the one or more sequence numbers; constructing one or more file-paths; and storing the file-path map in a local memory. In some embodiments, the method further comprises receiving a file-path selection; retrieving the file corresponding to the tile-path selection from the local memory; and displaying the definition elements stored in the file.

According to another embodiment, a computer program product may include a non-transitory computer-readable medium comprising code to perform the steps of receiving an input term comprising one or more workfile names; displaying a list of workfile contents; creating a file-path map for one or more of the workfile contents; receiving a query input; and displaying the file-path corresponding to the query input.

The medium may also include code to perform the steps of receiving a file-path selection; retrieving the file corresponding to the file-path selection from the local memory; and displaying the definition elements stored in the file.

According to yet another embodiment, an apparatus may include a storage device, a memory, and a processor coupled to the memory and storage device. The processor may be configured to execute the steps of receiving an input term comprising one or more workfile names; displaying a list of workfile contents; creating a file-path map for one or more of the workfile contents; receiving a query input; and displaying the file-path corresponding to the query input.

In some embodiments, the processor may further be configured to execute the steps of receiving a file-path selection; retrieving the file corresponding to the file-path selection from the local memory; and displaying the definition elements stored in the file.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that arc believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an IDE architecture according to one embodiment of the disclosure.

FIG. 2 is a diagram illustrating an example of a IDE user interface according to one embodiment of the disclosure.

FIG. 3 is a flow chart illustrating a method of referring to copy-proc files according to one embodiment of the disclosure.

FIG. 4 is a flow chart illustrating a method of creating a persistent map containing copy-proc names and file-paths according to one embodiment of the disclosure.

### DETAILED DESCRIPTION

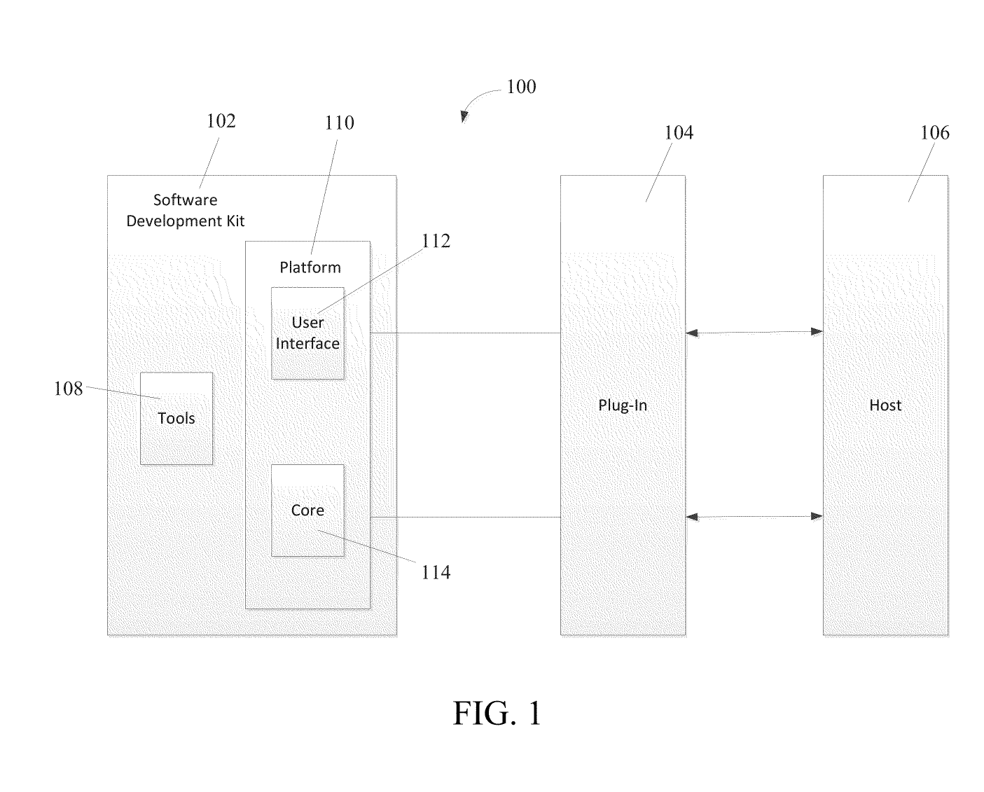

FIG. 1 illustrates one embodiment of an emulated IDE architecture 100 according to one embodiment of the disclosure. The architecture of IDE 100 may include a software development kit (SDK) 102, one or more plug-ins/modules 104, and one or more hosts/mainframes 1106. SDK 102 may include various software development tools 108 that allow a user to create software applications. SDK 102 may also include a platform 110 that may include a user interface 112 and a core 114. A user may use user interface 112 to access tools 108 and plug-ins 104 that support a variety of different programming options. Plug-ins 104 may be open source and may provide additional functionalities in a variety of categories, including application management, build and deploy, graphics, profiling, and testing. Plug-ins 104 may also provide access to transactions and databases in one or more hosts 106. Platform 110 may enable development in many different programming languages, such as, for example, Java, COBOL, and PLUS. Platform 110 may also enable the use of various network protocols, such as, for example, TelNet.

A user may download SDK 102 and access platform 110 on a suitable processor-based device such as a desktop computer, a laptop computer, a personal digital assistant (PDA) or tablet computer, a smartphone or other mobile communication device. In some embodiments, the processor-based device may access a network to access a web application or web service hosted by mainframes 106 and enable the user to enter or receive information via user interface 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

The applications of the present disclosure are not limited to IDE architecture 100 or any particular type of computer system. For example, any suitable processor-based device may be utilized including, without limitation, personal data assistants (RDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, a computer system may be virtualized for access by multiple users and/or applications.

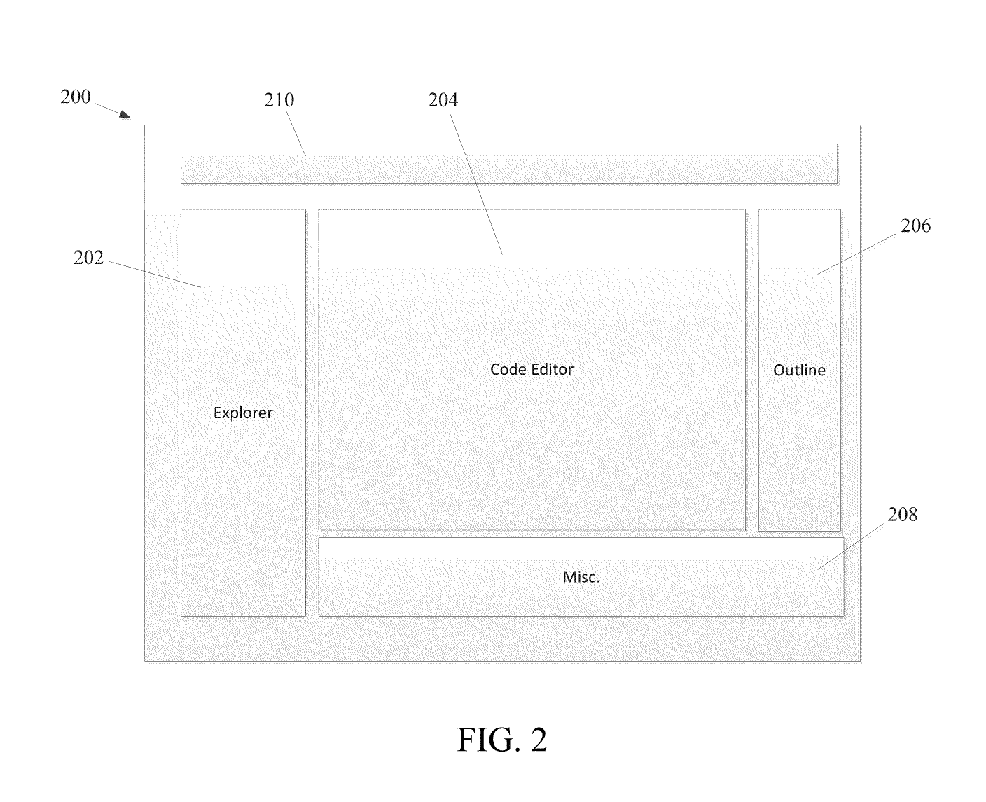

FIG. 2 illustrates an example of a perspective 200 of IDE user interface 112 according to one embodiment of the disclosure. Perspective 200 may comprise a view that allows the user to perform different development tasks. One or more windows 202, 204, 206, 208 may be provided, in various arrangements, to separate and organize various activities. These activities may comprise, for example, code editing, error checking, debugging, and searching, in the embodiment shown, perspective 200 comprises an explorer window 202, a code editor window 204, an outline window 206, and a miscellaneous or catch-ail window 208. Windows 202, 204, 206, 208 may be linked together such that an action performed in one window may have an effect in one or more of the other windows. Each window may have minimize and full-screen buttons to allow the user to minimize the window or expand the window to a full-screen view, respectively. Perspective 200 may also comprise one or more menu bars or icons 210 to enable a user to perform various user interface functionalities.

In some embodiments, explorer window 202 may enable the user to view a structured view of a project and its objects. A project may comprise one or more application source files, a mechanism to edit the files, and a workfile that contains currently worked-on objects and pieces, such all or portions of application source code. Each project and object may be represented by icons in a hierarchical structure to allow the user to navigate to a particular project and object by selecting a corresponding icon.

In some embodiments, code editor window 204 may enable the user to view and edit a particular section of code. Code editor window 204 may include a tab selection area at the top of the window. The user may open multiple sections of code that are represented by tabs. The user may select a tab to work on a particular section of code and may move to other sections by toggling the tabs. The user may add and delete code in the editor window and save any changes.

In some embodiments, outline window 206 may enable the user to view a structured view of the file being currently edited. Major sections of code within the file may be represented by icons in a hierarchical structure to allow the user to navigate to a particular section of code within the file by selecting a corresponding icon. This functionality allows for quick navigation to key sections of code that may need multiple edits.

In some embodiments, catch-all window 208 may enable the user to view miscellaneous activities and notifications. Examples of activities include tasks, problems, properties, bookmarks, and errors. Catch-all window 208 may include a tab selection area at the top of the window having tabs that represent various tasks. The user may select a tab to work on a particular task. Due to linking between the windows, a selection made in catch-all window 208 may effect changes in one or more other windows. For example, the user may select a tab in catch-all window 208 to access an error log. If the user clicks on a particular error, code editor window 204 may display the line of code containing the problem so the user can make edits.

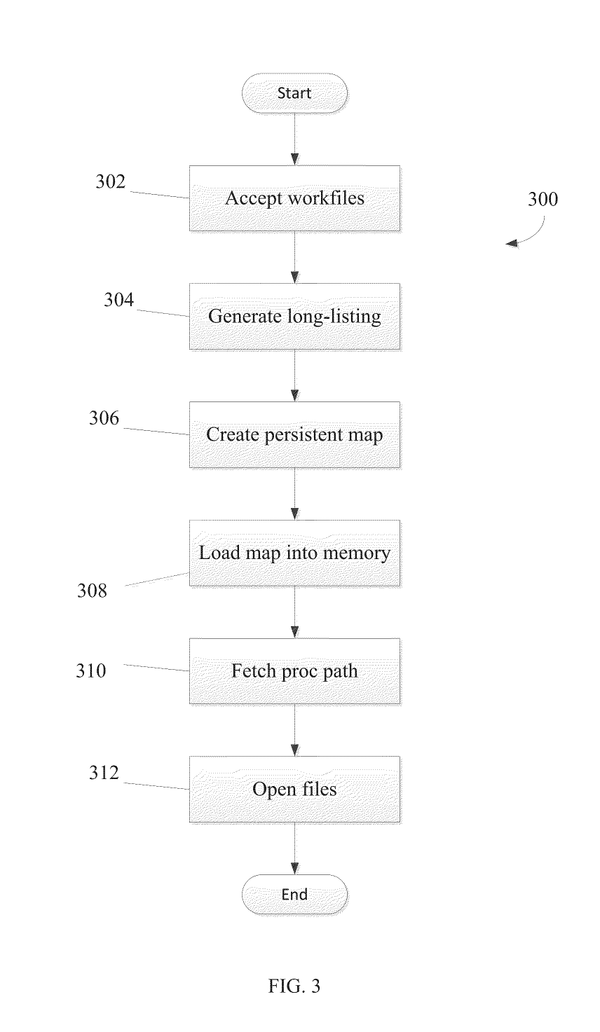

FIG. 3 is a flow chart illustrating a method of referring to copy-proc files according to one embodiment of the disclosure. In some embodiments, a user may perform this method using user interface 112. In certain embodiments, the copy-procs are separate files and need to be processed using a Procedure Definition Processor (PDP) before they can be referred in a COBOL program. Therefore, in the embodiment shown, the user needs to find and refer to the copy-proc definitions he wishes to implement in his program.

The method 300 may include, at block 302, accepting workfile inputs from the user that contain the copy-proc definitions that the user wishes to use. In the embodiment shown, the user may identify and input the workfiles that contain the elements of the copy-proc definitions. There may be many such workfiles for each host and there may be multiple copy-proc definitions in a single workfile.

In some embodiments, the user may input the workfile information into a dialog box. In some embodiments, the user may choose a connection or host name for which the copy-procs need to be configured. In some embodiments, the user may select an uneditable drop-down menu. The menu may contains a list of hosts that have been pre-configured with the IDE. The user may select a host name from the list to connect to that host. In other embodiments, the user may key-in a connection name. In some embodiments, the user may be presented with a list of projects associated with the chosen host. This list may provide a reference to the user so the user may view the projects that the user has created for the selected connection name.

In some embodiments, the user may also select a share option. In some embodiments, the share options may be implemented by the Common Internet File System (CES). In some embodiments using OS 2200, a radio-button for “os2200” may be selected by default. If this option is selected, a text-box may display the text “os2200” and remain uneditable. A user may select this option to access files having standard IDE filenames. In some embodiments, if the user desires to access a file having a non-standard IDE filename or access a tile from the workfile, the user may select an applicable radio-button to enable editing of the text-box. The user may then provide a valid share-name in the text-box. In sonic embodiments, the user may input the names of the workfiles that contain the copy-proc definitions.

The method 300 may include, at block 304, generating a long-listing of the workfile contents. In some embodiments, a TelNet session may be established. The user may enter an executive control language (ECL) statement in the TelNet session to generate the long-listing for each workfile specified by the user. In some embodiments, the ECL statement may in be the format “@PRT, TL <workfile-name>.” In some embodiments, the tong-listing may contain one or more of an element table, a COBOL procedure table, an assembler procedure table, a FORTRAN procedure table, a relocatable entry point table, and other various contents.

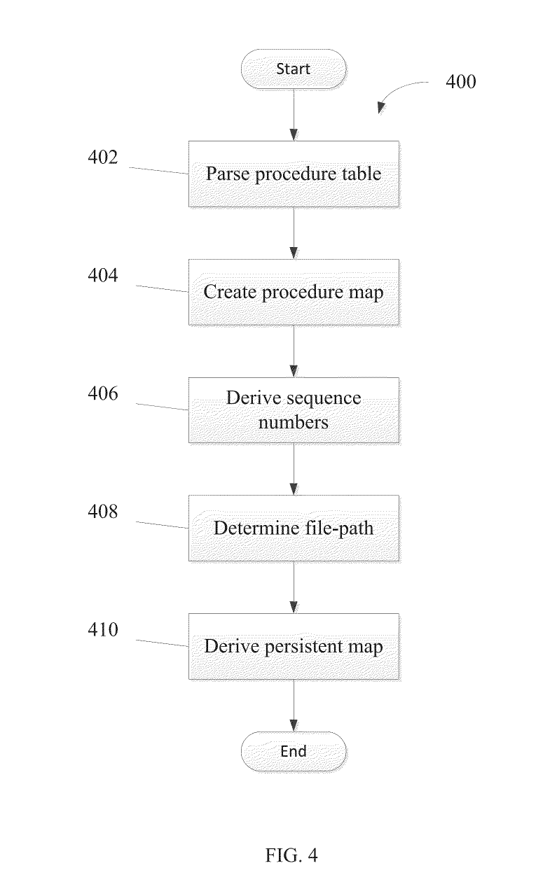

The method 300 may include, at block 306, creating a persistent map for the proc-names contained in the workfiles and their absolute paths. In some embodiments, the persistent map may be created by processing the long-listing. Method 300 may also include, at block 308, storing the persistent map in a local memory. These steps will be explained in more detail with reference to FIG. 4.

The method 300 may include, at block 310, fetching the file-paths of the copy-procs the user wishes to use. When using COBOL, a user may refer to a particular copy-proc by using a “COPY” statement in the COBOL program. For example, the user may insert the code “COPY P1RUN” into a program. This line of code would refer to a copy-proc named “P1RUN.” In certain embodiments, the user may view and edit code in code editor window 204.

In some embodiments, the user may query the host for the absolute file-path of a copy-proc. In some embodiments, the user may send a query by hovering a mouse-pointer over the name of a copy-proc listed in a program opened in code editor window 204. The query may access a hash table to search for a particular copy-proc name. If one or more entries are found, the user may view the absolute path of the element that contains the definition of the copy-proc. In some embodiments, the absolute path may be displayed in a pop-up window or tool-tip. For example, if a user hovers a mouse-pointer over the copy-proc name “P1RUN” in code editor window 204, the absolute path may appear in OS 2200 format (Qualifier*Filename.Element-name) in a pop-up window.

The method 300 may include, at block 312, opening one or more files and/or file elements. In some embodiments, the files may be opened when a user selects an absolute file-path link. Continuing the example above, the user may select the path displayed in the pop-up window for copy-proc name “P1RUN,” The absolute path may be used to open up that element in a separate editor tab in code editor window 204. The user may then access the copy-proc elements.

FIG. 4 is a flow chart illustrating a method of creating a persistent map containing copy-proc names and file-paths according to one embodiment of the disclosure. Method 400 may include, at block 402, processing a COBOL procedure table. In certain embodiments, the COBOL procedure table will be listed in the long-listing of the workfile contents created in method 300 at block 304. The COBOL procedure table may contain a list of COBOL copy-procs contained in the workfile. In some cases, the COBOL procedure table may be empty if the workfile contains no copy-procs. If the procedure table is populated, it may be parsed.

The method 400 may include, at block 404, creating a procedure map for each copy-proc in the workfile. In some embodiments, the procedure map may list a location and a name of each copy-proc in the workfile. In some embodiments, the map may be in the format <Key, Value> with location listed as “Key” and the copy-proc name listed as “Value.”

The method 400 may include, at block 406, deriving sequence numbers for each copy-proc in the workfile. In some embodiments, an element table will be listed in the long-listing of the workfile contents. The element table may list all the elements contained in the workfile. The element table may have a row for each element. In some embodiments, each row in the element table may be parsed to derive a sequence number for each element.

The method 400 may include, at block 408, determining an absolute file-path for the elements listed in the procedure map. In some embodiments, each derived sequence number may be queried in the procedure map. If a sequence number exists as a KEY location in the map, the filename VALUE may be extracted. In certain embodiments, when the KEY listed in the procedure map is found, an absolute path of the corresponding element in the element table is constructed. The absolute path may indicate the file-path of the element that contains the definition of the desired copy-proc.

Continuing the example above, the user may wish to refer to the file containing the definitions for the copy-proc “P1RUN.” In the long-listing of the workfile, parsing the procedure table may determine that the location of the definitions of copy-proc “P1RUN” corresponds to sequence number “161.” Hence, the procedure map may be created as <161, P1RUN>. In the long-listing of the workfile, each row of the element table may be parsed. A first element in the element table may be named “10K” and may correspond to sequence number “160.” The sequence number “160” may be queried in the procedure map. Because the procedure map contains sequence number “161,” it is determined that the sequence numbers do not match. Therefore, the entry for “10K” in the element table is ignored and the next row in the element table is processed. The second element in the element table may be named “P1DEF” and may correspond to sequence number “161.” The sequence number “161” may be queried in the procedure map. Because the sequence number of element “P1DEF” matches the sequence number of the procedure map, it is determined that element “P1DEF” contains the definitions of copy-proc “P1RUN.” The system may then construct the absolute path for the element “P1DEF” as \\Host-idShare\Qualifier\Filename\ElementName.

The method 400 may include, at block 410, deriving a persistent map. In some embodiments, after determining the absolute path of the element containing the definition of the copy-proc, the system may write this information in a specific folder on the local system and create a corresponding entry in the persistent map. Continuing the example above, the persistent map entry may be displayed as P1RUN \\Host-id\Share\Qualifier\Filename\P1DEF. The persistent map may contain entries for each copy-proc to be referred. In some embodiments, the persistent map and all corresponding folders may be saved in the local system. Similar to the procedure map, the persistent map may be in the format <Key, Value> with location listed as “Key” and the copy-proc name listed as “Value,” Using this format, the persistent map may be stored in a hash table for later retrieval when the user queries the name of a copy-proc.

The schematic flow chart diagrams of FIGS. 3 and 4 are generally set forth as logical flow chart diagrams. As such, the depicted order and labeled steps are indicative of one aspect of the disclosed methods. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

Those of skill would appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

In some embodiments, the techniques or steps of a method described in connection with the aspects disclosed herein may be embodied directly in hardware, in software executed by a processor, or in a combination of the two. In some aspects of the disclosure, any software module, software layer, or thread described herein may comprise an engine comprising firmware or software and hardware configured to perform aspects of the described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

While the aspects of the disclosure described herein have been described with reference to numerous specific details, one of ordinary skill in the art will recognize that the aspects of the disclosure can be embodied in other specific forms without departing from the spirit of the aspects of the disclosure. Thus, one of ordinary skill in the art would understand that the aspects described herein are not to be limited by the foregoing illustrative details, but rather are to be defined by the appended claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of referring to one or more copy processes (copy-procs) within an integrated development environment, comprising:
receiving an input term comprising one or more workfile names;
displaying a list of workfile contents;
creating a file-path map for one or more of the workfile contents;
receiving a query input; and
displaying the file-path corresponding to the query input.

2. The method of claim 1, wherein the one or more workfiles contain definition elements for one or more copy-procs.

3. The method of claim 2, wherein the list of workfile contents comprises:
a procedure table; and
an element table.

4. The method of claim 3, wherein creating the file-path map comprises:
parsing the procedure table;
creating a procedure map;
parsing the element table;
creating one or more sequence numbers;
correlating the procedure map and the one or more sequence numbers;
constructing one or more tile-paths; and
storing the file-path map in a local memory.

5. The method of claim 4, further comprising:
receiving a file-path selection;
retrieving the file corresponding to the file-path selection from the local memory; and
displaying the definition elements stored in the file.

6. A computer program product, comprising:
a non-transitory computer-readable medium comprising code to perform the steps of:
receiving an input term comprising one or more workfile names;
displaying a list of workfile contents;
creating a file-path map for one or more of the workfile contents;
receiving a query input; and
displaying the file-path corresponding to the query input.

7. The computer program product of claim 6, wherein the one or more workfiles contain definition elements for one or more copy-procs.

8. The computer program product of claim 7, wherein the list of workfile contents comprises:
a procedure table; and
an element table.

9. The computer program product of claim 8, wherein creating the file-path map comprises:
parsing the procedure table;
creating a procedure map;
parsing the element table;
creating one or more sequence numbers;
correlating the procedure map and the one or more sequence numbers;
constructing one or more file-paths; and
storing the file-path map in a local memory.

10. The computer program product of claim 9, further comprising code to perform the steps of;
receiving a file-path selection;
retrieving the file corresponding to the file-path selection from the local memory; and
displaying the definition elements stored in the file.

11. An apparatus, comprising:
a network interface card (NIC);
a memory; and
a processor coupled to the memory and to the network interface card (NW), the processor configured to execute the steps of:
receiving an input term comprising one or more workfile names;
displaying a list of workfile contents;
creating a file-path map for one or more of the workfile contents;
receiving a query input; and
displaying the file-path corresponding to the query input.

12. The apparatus of claim 11, wherein the one or more workfiles contain definition elements for one or more copy-procs.

13. The apparatus of claim 12, wherein the list of workfile contents comprises:
a procedure table; and
an element table.

14. The apparatus of claim 13, wherein creating the file-path map comprises:
parsing the procedure table;
creating a procedure map;
parsing the element table;
creating one or more sequence numbers;
correlating the procedure map and the one or more sequence numbers;
constructing one or more tile-paths; and
storing the file-path map in a local memory.

15. The apparatus of claim 14, further comprising code to perform the steps of:
receiving a file-path selection;
retrieving the file corresponding to the file-path selection from the local memory; and
displaying the definition elements stored in the file.
